(19) United States
(12) Patent Application Publication
(10) Pub. No.: US 2019/0179292 A1
(43) Pub. Date: Jun. 13, 2019

(54) SYSTEM AND METHOD FOR CARTON SERIALIZATION

(71) Applicant: W. H. Leary Co., Incorporated, Tinley Park, IL (US)

(72) Inventors: Daniel P. McCarty, Mokena, IL (US); Andrew Sims, Frankfort, IL (US); Kenneth J. Dalka, Naperville, IL (US)

(73) Assignee: W. H. Leary Co., Incorporated, Tinley Park, IL (US)

(21) Appl. No.: 16/213,325

(22) Filed: Dec. 7, 2018

Related U.S. Application Data
(60) Provisional application No. 62/595,743, filed on Dec. 7, 2017.

(51) Int. Cl. G05B 19/416

(52) U.S. Cl. CPC G05B 19/4166; G05B 2219/45054; G05B 2219/45153

(57) ABSTRACT

A system is described for carton serialization on a high-speed production line. The system includes conveying apparatus. A printer prints a unique character string on each piece of feed stock to uniquely identify each assembled carton. Folding and gluing apparatus are operatively associated with the conveying apparatus for selectively gluing and folding feed stock to form assembled cartons. An analysis apparatus monitors operation of carton assembly. A rejection device selectively removes defective assembled cartons from the conveying apparatus. A control system is in operative communication with the sensor, printer, folding and gluing apparatus, the analysis apparatus and the rejection device. The control system stores machine operating parameters in a database. The control system controls the printer to print the unique character string on each piece of feed stock responsive to the sensor and storing the unique character string and production time for each carton produced in a database.

### CROSS-REFERENCE TO RELATED APPLICATIONS

This application claims priority of Provisional Ser. No. 62/595,743, filed Dec. 7, 2017, the disclosure of which is hereby incorporated by reference in its entirety.

### FIELD OF THE INVENTION

This invention relates to high-speed production, gluing and folding of feed stock to form cartons and, more particularly, to carton serialization.

### BACKGROUND OF THE INVENTION

In carton assembly systems, the feed stock to form the carton moves on a conveyor past a glue station where glue is applied to a portion thereof. After the glue is applied to the carton, the carton is folded and pressure is applied to the carton while the glue dries. Sometime later, the cartons are filled with a product. If the cartons are improperly glued, the cartons may come apart, for example, during shipping, and the product may be damaged or lost. Therefore, it is desirable to detect improper assembly of the carton.

Particularly, typical packaging automation systems include high-speed lines which take feed stock in the form of precut and printed paperboard, or the like, and form a packaging product, such as a carton, box, bag, envelope, or the like. For simplicity herein, the packaging product will be referred to as a carton formed of paperboard. As will be apparent, the invention is not intended to be so limited.

Of relevance herein are systems which take the flat paperboard stock and at high speed add glue and fold the paperboard into a carton for use by the end customer. Such systems include apparatus for analyzing for improper placement of glue, folds, or the like and immediately rejecting the carton if an error is found without slowing down production.

However, if a carton is produced and shipped to the customer and there is subsequently an issue, then it would be useful to know how the carton was produced. Being able to track each carton produced and determine how it was produced provides advantages to satisfy a customer's needs and avoid future problem.

The present invention is directed to improving availability of and access to information on individual cartons.

### SUMMARY OF THE INVENTION

In accordance with the invention, high-speed production lines for carton assembly are adapted to include carton serialization to allow for analysis of each individual carton produced.

There is disclosed in accordance with one aspect a system for carton serialization on a high-speed production line for selectively gluing and folding feed stock to form an assembled carton. The system includes conveying apparatus for delivering feed stock from a feed unit to a delivery unit. A sensor senses feed stock entering the conveying apparatus. A printer prints a unique character string on each piece of feed stock to uniquely identify each assembled carton. Folding and gluing apparatus are operatively associated with the conveying apparatus for selectively gluing and folding feed stock to form assembled cartons. An analysis apparatus monitors operation of carton assembly. A rejection device selectively removes defective assembled cartons from the conveying apparatus. A control system is in operative communication with the sensor, printer, folding and gluing apparatus, the analysis apparatus and the rejection device. The control system stores machine operating parameters in a database. The control system controls the printer to print the unique character string on each piece of feed stock responsive to the sensor and storing the unique character string and production time for each carton produced in the database. The control system selectively provides serialization reports providing machine operating parameters for each assembled carton.

It is a feature that the control system triggers timing of the printer based on a signal from the sensor and speed of the conveying apparatus.

It is another feature that the control system transfers a selected character string to the printer at the beginning of each print operation, and the printer selectively increments the character string printed on each carton responsive to receiving a print command from the control system.

It is another feature that the printer sends a print acknowledgement signal to the control system after printing the unique character string on each carton. The control system may wait for the print acknowledgement signal after triggering the printer to ensure that the system maintains synchronization. The control system is adapted to selectively stop the conveying apparatus, stop a feeding apparatus or take no action if the system does not maintain synchronization.

It is a further feature to provide a remote processing system in operative communication with the control system for remotely accessing real-time data, statistics and reports for any carton produced by using the unique character string.

It is yet another feature that for each carton removed by the rejection device, the control system stores a specific reason for rejection associated with the unique character string for the carton.

It is an additional feature to provide a remote database and the control system periodically uploads production data and serialization of reports from the database to the remote database.

It is still a further feature that an image analysis device operatively associated with the control system reads the unique character string to ensure proper printing of the unique character string.

There is disclosed in accordance with another aspect a method for carton serialization on a high-speed production line for selectively gluing and folding feed stock to form an assembled carton comprising: providing a conveying apparatus for delivering carton feed stock from a feed unit to a delivery unit; sensing feed stock entering the conveying apparatus; printing a unique character string on each piece of carton feed stock to uniquely identify each resulting assembled carton; automatically gluing and folding carton feed stock fed on the conveying apparatus to form assembled cartons; monitoring operation of carton assembly; selectively removing defective assembled cartons from the conveying apparatus; and operating a control system to store machine operating parameters in a database, the control system controlling the printing of the unique character string on each piece of carton feed stock responsive sensing feed stock entering the conveying apparatus and storing the unique character string and production time for each carton produced in the database, and the control system selectively providing serialization reports providing machine operating parameters for each assembled carton.

Further features and advantages will be readily apparent from the specification and from the drawings.

### BRIEF DESCRIPTION OF THE DRAWINGS

FIG. 1 is a generalized block diagram illustrating an exemplary production system and method for carton assembly;

FIG. 2 is a more detailed block diagram of a control system for the production system of FIG. 1;

FIG. 3 is a diagrammatic representation illustrating timing and distance for operation on the production line;

FIG. 4 is a flow diagram illustrating operation of software implemented in the control system of FIGS. 1 and 2;

FIG. 5 is a state diagram illustrating printer control in the control system of FIGS. 1 and 2;

FIG. 6 is a plan view of exemplary unfolded feed stock; and

FIG. 7 is a plan view of a carton formed from the feed stock of FIG. 6.

### DETAILED DESCRIPTION OF THE INVENTION

As described herein, a carton assembly system and method are provided with apparatus and methodology for implementing carton serialization which prints a unique carton ID on each carton produced. The system sends job setting and carton ID information to a database which allows a user to query a specific carton ID and obtain the job settings used and time when the carton was produced. Also, the user can query information for a failed carton, such as the specific failure reason and chronological data related to that carton.

Complete process information about each carton, including precise gluing and quality assurance settings, is available. Such reports allow carton producers to understand the root cause of issues and offer immediate corrective action to avoid future problems. Serialization reports provide answers about each individual carton including, for example, when the carton was produced, what machine the carton was produced on, which detection settings were activate, issues with the preceding or subsequent cartons, the job settings, and the last machine stop prior to production of the carton at issue. Analysis can be used to reject cartons if a problem is found.

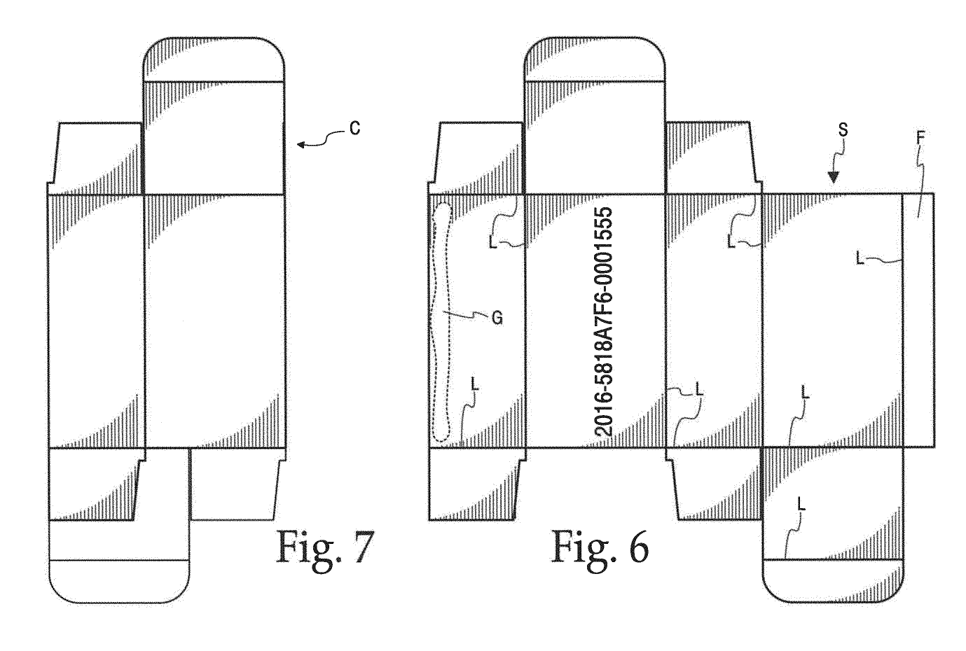

FIG. 6 illustrates a sample of flat feed stock S cut into a desired shape. The stock S has plural fold lines L. A glue area G represents an area where glue will be applied to adhere to a flap F after folding. The resultant carton C is shown in FIG. 7.

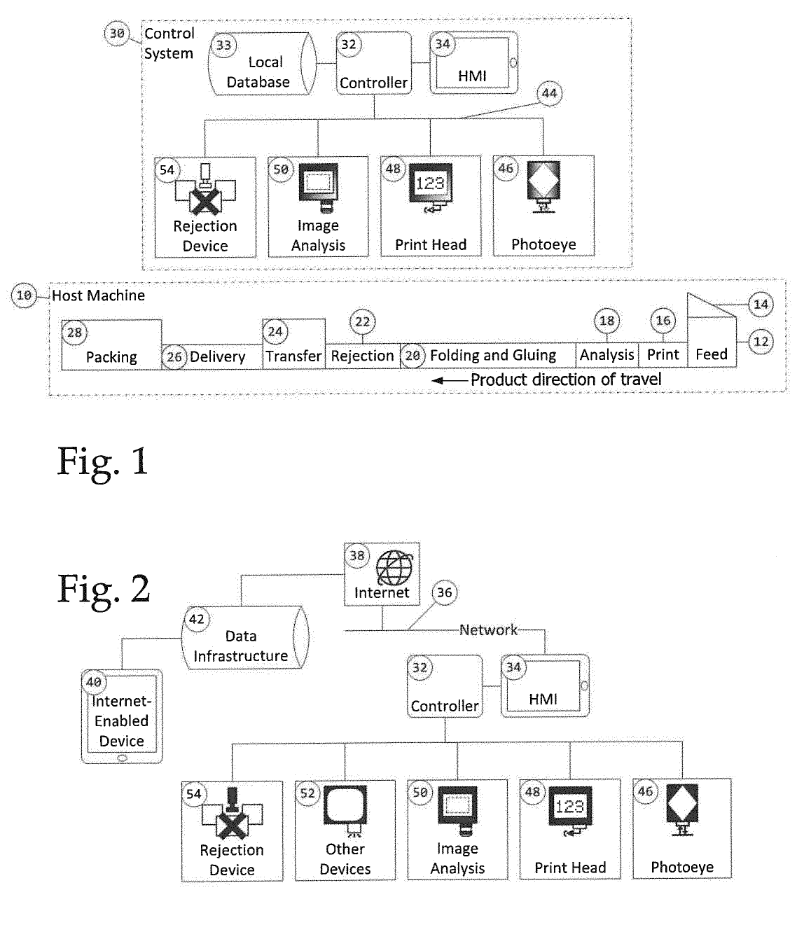

Referring to FIG. 1, a generalized block diagram illustrates an exemplary system for carton assembly. The system comprises a high-speed line 10. The line 10 comprises a conveying apparatus that may produce up to 200,000 cartons per hour. The throughput of the line will depend, in part, on the carton size. Larger cartons allow the print to be “stretched” more and therefore could be run at higher speed than with smaller cartons. The line 10 includes a feed unit 12 which feeds stock from a bin 14. The stock would typically be a flat, precut paperboard item, see FIG. 6, printed according to the user requirements. The stock is fed to a print section 16 which prints a unique product ID code on the carton. An analysis section 18 is optionally used to verify the product ID code.

Thereafter, the line 10 includes a folding and gluing section 20 which applies glue, as necessary, to appropriate places on the carton and subsequently folds the carton into its assembled state. A rejection section 22 is employed to reject a carton when an error has been found in the folding and gluing section 20. If not rejected, then the cartons proceed via a transfer section 24 to a delivery section 26 and subsequently to a packing section 28 for delivery to the customer.

The configuration of the line 10 herein is intended to be by way of example only. The particular configuration of the line 10 is entirely dependent on the requirements for carton assembly. For example, there may be multiple gluing stations and fold stations, as necessary or desired. An example of such a system is illustrated in Leary et al U.S. Pat. No. 5,375,722, owned by the assignee of the present application, the specification of which is incorporated by reference herein.

This application is particularly directed to the use of carton serialization on such a line 10 to improve monitoring capabilities and analysis of individual cartons produced.

The line 10 is controlled by a local control system 30. The control system 30 includes a programmed controller 32 which comprises a computer base controller including appropriate memory, such as a local database 33, storing control programs and data. The controller 32 is connected to a user interface device 34, such as a touch screen monitor. The controller 32 may be connected via a network 36 to the Internet 38, see FIG. 2. A remotely located database, identified as data infrastructure 42, also stores production data, as described. A remote Internet enabled device 40 may be connected to the remote database 42 for remotely accessing real-time data, statistics, and reports for carton producers.

The control system 30 uses known dynamic operating software for electronic gluing and quality assurance. The control system 30 is capable of ‘learning’ its glue pattern, is pre-programmed with a plurality of standard folded box designs and detects and automatically adjusts glue applications on the run. Conventional data collection software allows the controller 32 to send real-time statistical data to the remote database 42. All data contained in the systems' production reports are sent through the network, creating archived data and allowing tracking capabilities for basic or sophisticated production analysis. The software also allows download of data to industry standard (PDF, CSV, XLS) files, and integration via programmatic API access directly to the remote database 42.

Standard production reports such as job tracking, production totals, total waste, down codes and defects are provided through the data collection software. Custom reports may also be generated based on specific plant criteria. Each of the reports can be customized by the user, making the program easy to run and eliminating the need for any in-house programming expertise.

The controller 32 includes plural I/O channels 44 for interfacing with peripheral devices. The peripheral devices may include a sensor 46 for detecting presence of feed stock on the conveying apparatus. A printer 48 includes a print head for printing the unique ID code. Optional image analysis device 50 can read the printed unique ID code as well as any other necessary information. Other known devices 52, see FIG. 2, are used for applying glue, detecting glue, detecting other aspects of the carton production, and the like. A rejection device 54 is operable to displace a carton from the line in the rejection section 22, if an error has been detected by the devices 52, or the image analysis 50.

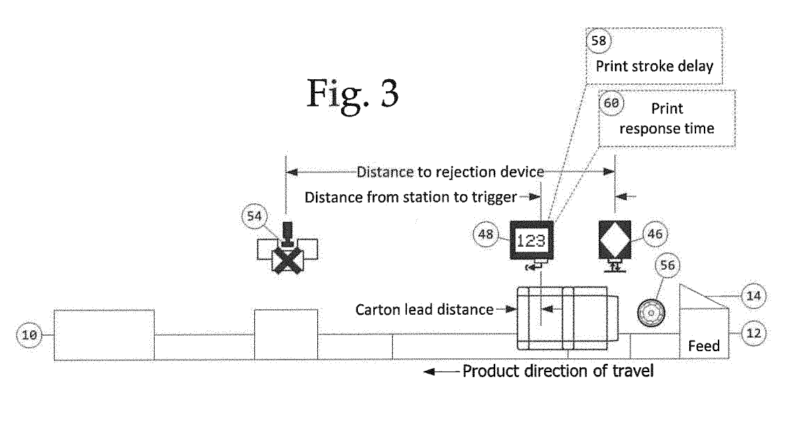

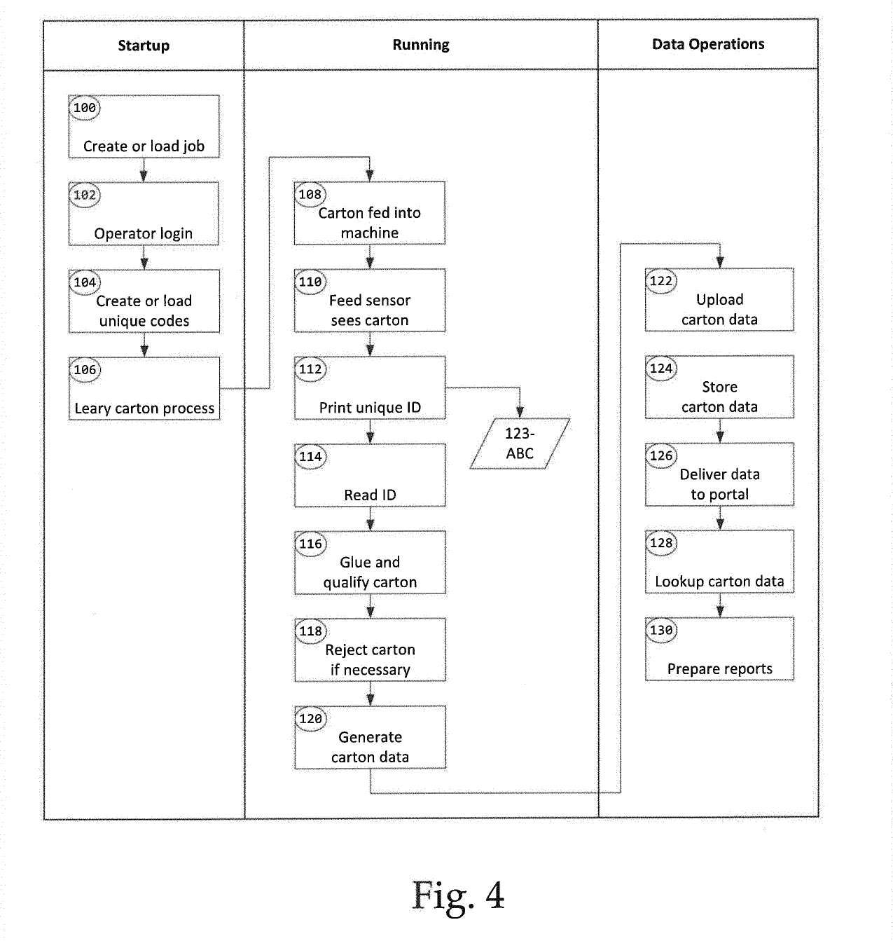

FIG. 3 illustrates the timing relationship between various elements for controlling the printer 48 for printing the unique ID. The line 10 also includes an encoder 56 which senses line speed proximate the printer 48. The figure shows a sample carton C which is conveyed on the line 10 from right to left from the feed bin 14 of the feed unit 12. The sensor 46, such as a photo eye, is a select distance ahead of the print head of the printer 48. The system must also know a carton lead distance which is a user defined space between the leading edge of the carton C to the position on the carton C where the unique ID is to be printed. Based on the carton lead distance and the distance from the printer 48 to the photo eye 46, and knowing the speed sensed by the encoder 56, the controller 32 can determine how long after receiving the trigger signal to initiate operation of the printer 48. Moreover, the system must take into account any print stroke delay, as indicated at a block 58 and print response time as indicated at a block 60 to determine when the print command should be sent to the printer 48. The controller 32 must also know the distance to the rejection device 54 as any errors must be sensed during the time that the carton transitions to the rejection device 54 if an error is detected.

Referring to FIG. 4, a flow diagram illustrates the methodology used with the control system 30 for controlling operation of the line 10. Particularly, the system is adapted for implementing a method for carton serialization.

The control system 30 begins during startup for a “job” at a block 100 which creates and loads information for the job. The job would relate to the production of a particular carton for a customer and defines parameters for folding and gluing and the like, in a conventional manner. An operator then logs in at a block 102 and creates or loads the unique ID codes at a block 104. The parameters for such codes are discussed in greater detail below. The control system 30 then learns the carton process at a block 106 which determines how the folding and gluing sections 20 will be controlled to assemble the carton.

Machine operation is then described for a “running” operation beginning at a block 108 where the feed stock for a carton C is fed from the feed unit 12. Once the feed sensor 46 senses a carton C, at a block 110, then the controller 32 sends a command at a block 112 to print the unique ID on the individual carton C. The unique ID is printed using the printer 48. The printer 48 is triggered based on the signal from the sensor 46 and knowing line speed, as discussed above. An example of a carton C is shown adjacent the block 112 showing a unique code “123-ABC” printed thereon. As is apparent, the control system 32 could print a non-alpha numeric code, such as a string encoded in other code symbologies, or as a data matrix.

The image analysis device 50 reads the printed ID code at a block 114. The image analysis device 50 may be anywhere downstream of the printer 48. A block 116 control various aspects of the folding and gluing section 20 to glue and fold the carton, as necessary for the particular job, and uses the available monitoring apparatus to determine if the particular carton is acceptable. The carton may be rejected at a block 118, based on the ID being improperly printed, as determined at the block 114, or based on control of the quality assurance software at the block 116. The carton data and machine data corresponding to the time at which the individual carton C is produced is stored in the local database 33 at a block 120.

The operation relative to the blocks 108-120 is continually implemented as long as the line continues to run which, as noted above, may be at speeds up to 200,000 cartons per hour. While the individual blocks are listed sequentially, various operations are performed simultaneously as multiple cartons are present on the line at any given time. The sequence is described for a single carton and is repeated for each and every carton being assembled, as is apparent.

Periodically during the run, or at the conclusion of the run, the carton data is uploaded from the local database 33 to the remote database 42 at a block 122 and stored at a block 124. The data is then available for delivery to a portal accessed via the device 40, see FIG. 2, at a block 126 so that a user can look up carton data at a block 128 and to determine system operation at the time that any particular carton or cartons were produced, as described more particularly below. Reports can also be prepared at a block 130 for viewing and/or printing.

In an exemplary embodiment, the controller 32 prints a unique string on each carton, see FIG. 6. The unique string may include indicia representing the machine line number, the start time of the current job and the unique carton number. As will be appreciated, other unique strings may also be used, such as customer supplied codes. The controller 32 sends a digital I/O print signal to the printer 48 for each carton. The printer 48 may be, for example, a Domino continuous ink jet printer. The printer 48 will print the string that was given when it receives a signal. The printer 48 sends a successful acknowledgment to the controller 32. The printer 48 will also increment the string by one so that the next carton will have a unique string printed.

The exact time of when the printer 48 is triggered is based on several factors, such as the signal from the sensor 46, line/machine speed, the print delay 58 specified in the printer configuration, the printer dot pitch, the time it takes for the ink to drop from the print head (print response time 60), the distance from sensor 46 to the printer 48, and the desired location for the print to begin on the carton.

The printer 48 is managed by the controller 32 using a software finite state machine (FSM). The software transitions from one state to another when an event occurs.

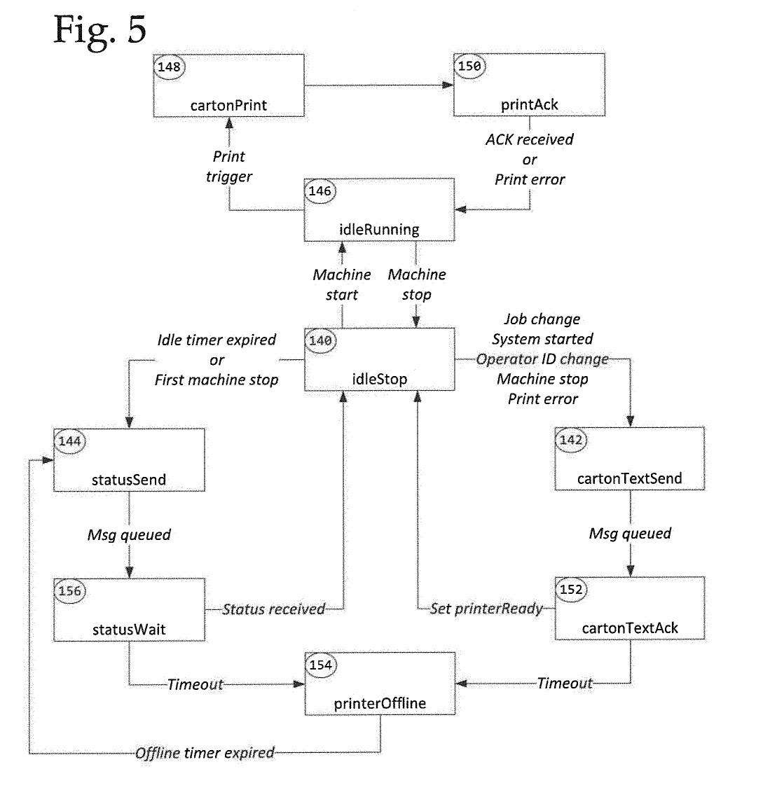

FIG. 5 illustrates the various states and events for transitioning from one state to another. Each state in the machine is shown as a block in FIG. 5. Each line in the diagram is an event.

The FSM is initialized to an idleStopped state 140 which means that the line 10 is stopped. If the control system 30 has just started, then the FSM transitions to the cartonTextSend state 142 to instruct the printer 48 what to print. Also, when the job has changed, the FSM transitions to the cartonTextSend state 142 to instruct the printer what to print. Likewise, if the operator ID has changed, the FSM transitions to the cartonTextSend state 142 to instruct the printer what to print. If a printing error occurred while printing, the FSM transitions to the cartonTextSend 142 state to instruct the printer what to print. When an idle timer expires or at a first machine stop, the FSM transitions to a statusSend state 144 to check the printer status. If the machine starts, the FSM transitions to an idleRunning state 146.

If the FSM is in the idleRunning state 146 the machine is running as at the blocks 108-120 of FIG. 4. When each carton reaches the proper position under the print head, as discussed above, and the FSM transitions to a cartonPrint state 148 to trigger the printer 48 to print. If the machine stops, the FSM transitions to the idleStopped state 140.

If the FSM is in the cartonPrint state 148 the printer 48 is signaled to print. The printer 48 is activated and the FSM transitions to a printAck state 150 to wait for an acknowledgement (ACK).

If the FSM is in the printAck state 150 it is waiting for an ACK from the printer 48. If an ACK from the printer 48 is received, the FSM transitions to the idleRunning state 146. If the ACK wait timer expires, the FSM takes the action it is configured for on printer errors and transitions to the idleRunning state 146.

If the FSM is in the cartonTextSend state 142 it will send the text to print to the printer 48. The controller 32 sends the current text to be printed to the printer 48 and transitions to a cartonTextAck state 152 to wait for an acknowledgement while the message is queued.

If the FSM is in the cartonTextAck state 152 it is waiting for an ACK from the printer 48. When an acknowledgement that the printer is ready is received from the printer 48, the FSM transitions to the idleStopped state 140. If the wait timer expires, the FSM assumes the printer 48 is offline and transitions to the printerOffline state 154.

If the FSM is in the statusSend state 144 it is sending a status request to the printer 48. The FSM sends a status request message to the printer and transitions to a statusWait state 156 to wait for an acknowledgement.

If the FSM is in the statusWait state 156 it is waiting for status response. If a status response is received the FSM transitions to the idleStopped state 140. If the wait timer expires, the FSM assumes the printer is offline and transitions to the printerOffline state 154.

If the FSM is in the printerOffline state 154 the printer is not responding. When the wait timer expires the FSM transitions to the statusSend state 144 to check if the printer 48 is back online.

The print string transferred from the controller 32 to the printer 48 typically consists of at least one of several identifying pieces of information, such as the machine number, the start time of the job, and the carton ID within that job. Users may also choose to print other identifying information, such as an ID of the operator running the machine, a timestamp, or other custom-supplied information.

An operator may login at any time or be automatically asked to login at a shift change. This process is made easier by use of a fingerprint scanner. Once the operator registers a fingerprint, he or she can then quickly login to the system at the block 102. This may affect the printed code if the option is chosen to print the operator's name or initials on the carton.

The commands used to set the print string on the printer 48 may require up to 500 ms for the printer 48 to process. At typical machine speeds, several cartons would pass by the print head in that amount of time. Therefore, the print string cannot be given to the printer 48 for each carton printed if the machine is to be run at high speeds.

To mitigate this issue, the print string is sent to the printer 48 each time the job changes and whenever the machine is stopped. Furthermore, the job cannot be changed while the machine is running. Also, the printer 48 is configured to increment the carton ID portion of the string each time it is triggered to print. Each time the printer 48 is triggered to print, the printer 48 provides an acknowledgement that the operation was performed successfully, as described above. After triggering the printer 48, the controller software waits for the acknowledgement and treats the carton as a reject if the acknowledgement does not arrive in the expected timeframe. Any carton that is not printed on is treated as a reject.

The interactions between the controller 32 and the printer 48 can be complex, and several synchronization challenges can arise. There are some specific methodologies employed to overcome these challenges.

One option is to stop the entire line 10. After triggering the printer 48, the controller software waits for the acknowledgement and stops the line 10 if the acknowledgement does not arrive in the expected timeframe. Once the line 10 stops, a new print string is sent to the printer 48. This guarantees that the carton ID on the printer 48 and the controller 32 stay in sync.

Another option is to stop the line feed only. After triggering the printer 48, the controller software waits for the acknowledgement and stops the line's feed unit 12 if the acknowledgement does not arrive in the expected timeframe. Once the feed stops, a new print string is sent to the printer 48. The feed unit 12 can then be manually or electronically restarted. This guarantees that the carton ID on the printer 48 and the controller 32 stay in sync while minimizing disruption to production caused by a line shutdown.

Still another option is to Resync the line. After triggering the printer 48, the controller software waits for the acknowledgement and attempts to resync with the printer 48 if the acknowledgement does not arrive in the expected timeframe. To resync, the controller 32 will send a new print string to the printer 48 and reject all cartons that pass the printer head until the printer 48 has acknowledged that it will begin using the new print string.

The final option is to take no action. This setting prioritizes line production and instructs the controller 32 to not stop the line 10 or feed unit 12 if a carton does not receive a printed string. With this setting, the controller 32 may end up out of sync.

The job start time is advantageously printed on the carton in a condensed format with as few characters as possible. The job start time is printed using the English alphabet. However, some characters of the alphabet are not used to make the string as readable and clear as possible, prevent look-alike characters, and prevent undesirable words from appearing in a global setting. The job start time is calculated as the number of seconds since an epoch in a 32-bit unsigned value. It is printed in base 24 with the following characters: {‘3’, ‘4’, ‘7’, ‘8’, ‘9’, ‘B’, ‘C’, ‘D’, ‘F’, ‘G’, ‘H’, ‘J’, ‘K’, ‘L’, ‘M’, ‘N’, ‘P’, ‘Q’, ‘R’, ‘T’, ‘V’, ‘W’, ‘X’, ‘Y’}. Using 6 characters in base 24 leads to 191,102,976 possible combinations. Using this methodology, the job start time value consists of a unique value for over six years from the date of printing.

The described system tracks whenever a system setting, or job setting is changed. The tracking information includes the first carton ID to pass the feed trigger after the change is made. When a customer wants to know the system and job settings associated with a carton, a range check is performed to determine the system and job setting information associated with a specific carton. This is done to optimize storage, since a machine may produce hundreds of thousands or even millions of cartons per day. Thus, even though a particular carton may not have data specifically associated with it, the information about how the carton was produced can be obtained because of the range check.

Because the carton data is stored in a remote database 42, the carton does not need to be physically present in order to look up data about the carton.

For cartons that are rejected, a greater level of detail is needed, and they are tracked and stored individually. Several important details are stored for later display to a user, such as, but not limited to the carton ID printed on the carton; Associated job name and start time; Associated operator; Reason for rejection; The tolerance settings in use; All stations active at the time, and their configurations; Other controller functions, such as whether alarms were active or disabled, and other critical settings.

Thus, as described, the serialization allows a user to track carton production and trace issues that may arise subsequent to delivery of a carton.

The present invention has been described with respect to flowcharts and block diagrams. It will be understood that each block of the flowchart and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

It will be appreciated by those skilled in the art that there are many possible modifications to be made to the specific forms of the features and components of the disclosed embodiments while keeping within the spirit of the concepts disclosed herein. Accordingly, no limitations to the specific forms of the embodiments disclosed herein should be read into the claims unless expressly recited in the claims. Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

The foregoing disclosure of specific embodiments is intended to be illustrative of the broad concepts comprehended by the invention.

We claim:

1. A system for carton serialization on a high-speed production line for selectively gluing and folding feed stock to form an assembled carton comprising:
a conveying apparatus for delivering feed stock from a feed unit to a delivery unit;
a sensor for sensing feed stock entering the conveying apparatus;
a printer for printing a unique character string on each piece of feed stock to uniquely identify each resulting assembled carton;
folding and gluing apparatus operatively associated with the conveying apparatus for selectively gluing and folding feed stock to form assembled cartons;
analysis apparatus for monitoring operation of carton assembly;
a rejection device for selectively removing defective assembled cartons from the conveying apparatus; and
a control system in operative communication with the sensor, the printer, the folding and gluing apparatus, the analysis apparatus and the rejection device, the control system storing machine operating parameters in a database, the control system controlling the printer to print the unique character string on each piece of feed stock responsive to the sensor and storing the unique character string and production time for each carton produced in the database, and the control system selectively providing serialization reports providing machine operating parameters for each assembled carton.

2. The system for carton serialization of claim 1 wherein the control system triggers timing of the printer based on a signal from the sensor and speed of the conveying apparatus.

3. The system for carton serialization of claim 1 wherein the control system transfers a select character string to the printer at a beginning of each print operation and the printer selectively increments the character string printed on each carton responsive to receiving a print command from the control system.

4. The system for carton serialization of claim 1 wherein the printer sends a print acknowledge signal to the control system after printing the unique character string on each carton

5. The system for carton serialization of claim 4 the control system waits for the print acknowledgment signal after triggering the printer to ensure that the system maintains synchronization.

6. The system for carton serialization of claim 5 wherein the control system is adapted to selectively stop the conveying apparatus, stop a feeding apparatus or take no action if the system does not maintain synchronization.

7. The system for carton serialization of claim 1 further comprising a remote processing system in operative communication with the control system for remotely accessing real-time data, statistics and reports for any carton produced using the unique character string.

8. The system for carton serialization of claim 1 wherein for each carton removed by the rejection device the control system stores a specific reason for rejection associated with the unique character string for the carton.

9. The system for carton serialization of claim 1 further comprising a remote database and the control system periodically uploads production data and serialization reports from the database to the remote database.

10. The system for carton serialization of claim 1 further comprising an image analysis device operatively associated with the control system for reading the unique character string to ensure proper printing of the unique character string.

11. A method for carton serialization on a high-speed production line for selectively gluing and folding feed stock to form an assembled carton comprising:
providing a conveying apparatus for delivering carton feed stock from a feed unit to a delivery unit;
sensing feed stock entering the conveying apparatus;
printing a unique character string on each piece of carton feed stock to uniquely identify each resulting assembled carton;
automatically gluing and folding carton feed stock fed on the conveying apparatus to form assembled cartons;
monitoring operation of carton assembly;
selectively removing assembled defective assembled cartons from the conveying apparatus; and
operating a control system to store machine operating parameters in a database, the control system controlling the printing of the unique character string on each piece of carton feed stock responsive sensing feed stock entering the conveying apparatus and storing the unique character string and production time for each carton produced in the database, and the control system selectively providing serialization reports providing machine operating parameters for each assembled carton.

12. The method for carton serialization of claim 11 wherein the control system triggers timing of printing based on sensing feed stock entering the conveying apparatus and speed of the conveying apparatus.

13. The method for carton serialization of claim 11 wherein the control system transfers a select character string to a printer at a beginning of each print operation and the printer selectively increments the character string printed on each carton responsive to receiving a print command from the control system.

14. The method for carton serialization of claim 13 wherein the printer sends a print acknowledge signal to the control system after printing the unique character string on each carton

15. The method for carton serialization of claim 14 the control system waits for the print acknowledgment signal after triggering the printer to ensure that the system maintains synchronization.

16. The method for carton serialization of claim 15 wherein the control system is adapted to selectively stop the conveying apparatus, stop a feeding apparatus or take no action if the system does not maintain synchronization.

17. The method for carton serialization of claim 11 further comprising a providing a remote processing system in operative communication with the control system for remotely accessing real-time data, statistics and reports for any carton produced using the unique character string.

18. The method for carton serialization of claim 11 wherein for each carton removed the control system stores a specific reason for rejection associated with the unique character string for the carton.

19. The method for carton serialization of claim 11 further comprising a remote database and the control system periodically uploads production data and serialization reports from the database to the remote database.

20. The method for carton serialization of claim 11 further comprising image analysis for reading the unique character string to ensure proper printing of the unique character string.
